(19) United States
(12) Patent Application Publication
(10) Pub. No.: US 2023/0002979 A1
(43) Pub. Date: Jan. 5, 2023

(54) PAVING DEVICE

(71) Applicant: HYDROFORCE WORLDWIDE PTY LTD, Cheltenham (AU)

(72) Inventor: Eduard Christiaan SENT, Bonbeach (AU)

(73) Assignee: HYDROFORCE WORLDWIDE PTY LTD, Cheltenham (AU)

(21) Appl. No.: 17/902,950

(22) Filed: Sep. 5, 2022

Related U.S. Application Data
(63) Continuation-in-part of application No. PCT/AU2020/000055, filed on Jun. 23, 2020.

(30) Foreign Application Priority Data
Mar. 6, 2020 (AU) 2020900693

(51) Int. Cl. E01C 5/06; B28B 1/087

(52) U.S. Cl. CPC E01C 5/065; B28B 1/087; E01C 2201/20

(57) ABSTRACT

There is disclosed a paving member comprising: a body having a base configured to be supported on a ground surface and a surface configured to support traffic thereon, the body comprising a combination of aggregate and cement mixed at a ratio of 5:1 such that the body is permeable to water to facilitate collection of water therein and delivery of said water to said ground surface.

### RELATED APPLICATION(S)

The present application claims priority from Australian provisional patent application no. 2020900693 filed 6 Mar. 2020, the entire contents of which are incorporated herein by reference.

### FIELD OF INVENTION

The present invention relates generally to a paving device for the formation of ground structures, and in particular, to a paving device for creating a paved surface which is water permeable, safe and of sufficient strength to support a significant load.

### BACKGROUND OF THE INVENTION

With the increase in world population and as the effects of global warming become more understood, the ability of communities to manage water, especially waste or run-off water, is becoming especially important. As residential and public spaces become more densely populated, paved walkways and roads for handling traffic are replacing many grassed areas and ground spaces. Thus, especially in new residential developments where large houses are being built on small blocks in close proximity to other houses, rain water is more likely to be captured in drains or to flow into gutters or other dedicated water drainage systems than to be captured in the ground surface and be retained in the soil.

Such water drainage systems remove the water from the site into dedicated stormwater collection systems which ultimately deliver the rainwater back into the neighbouring rivers or oceans. As a result, the groundwater or water table in the region becomes diminished, minimising the amount of water present in the ground to support plants and trees. In many new developments, especially those in drought areas or in areas where rain water is largely collected and removed from the site, the soil structure is becoming increasingly dry and is beginning to contract and subside. Such a phenomena will result in foundation slabs for houses and other buildings becoming stressed and fracturing, compromising the integrity of such buildings and requiring significant costs and expertise to resolve. Thus, there is a social and an environmental benefit in allowing rainwater to be captured in the ground so as to infiltrate into the water table or, alternatively, to be harvested for re-use in irrigation, rather than merely removing it from the site.

A variety of water permeable paving systems have been proposed to address this problem and to facilitate capture and release of water into the underlying ground soil. However, most such paving systems rely upon a gap between adjacent paving bricks of the paved surface to act as a water permeable medium, through which water is able to flow to the underlying ground soil. In such arrangements, aggregate material is typically used to fill a space between adjacent paving bricks such that water passing over the paving bricks will flow into the spaces there between and be absorbed into the ground surface or water collection system below the paving.

Whilst such a system is able to provide a means for capturing water for release to the underlying ground surface, the amount of water captured largely relies upon the size of the spacing between pavers, with larger spacing sizes capturing the most water. Therefore, the paving system must have pavers separated by aggregate which can significantly limit the aesthetic appeal and safety of the walking surface of such paving. Most importantly, the gaps or joints between the paving bricks invariably become clogged with debris within a short time, thereby eliminating or substantially compromising the permeability. As each paver is not, in itself, pervious, permeability can only be restored by regularly cleaning the installation using commercial-grade vacuuming equipment. The maintenance regime is labour intensive and costly and often neglected.

Therefore, there is a need to provide a paving system whereby the individual pavers are configured to be permeable to water such that the paving can form, not only a path for traffic and pedestrians, but also capture water for release into a harvesting system or underlying ground surface.

The above references to and descriptions of prior proposals or products are not intended to be, and are not to be construed as, statements or admissions of common general knowledge in the art. In particular, the above prior art discussion does not relate to what is commonly or well known by the person skilled in the art, but assists in the understanding of the inventive step of the present invention of which the identification of pertinent prior art proposals is but one part.

### STATEMENT OF INVENTION

The invention according to one or more aspects is as defined in the independent claims. Some optional and/or preferred features of the invention are defined in the dependent claims.

Accordingly, in one aspect of the invention there is provided a paving member comprising:
a body having a base configured to be supported on a ground surface and a surface configured to support traffic thereon, the body comprising a combination of aggregate and cement mixed at a ratio of 5:1 such that the body is permeable to water to facilitate collection of water therein and delivery of said water to said ground surface.

In one embodiment, the body may have a water permeability rate of at last 300 mm per hour.

The body may be configured to have a shape that facilitates interlocking with other paving members.

The aggregate may comprise crushed natural stone. The natural stone may be marble, basalt, granite or any other similar stone material marble. The aggregate may vary in sizes having diameters of between 1 mm-7 mm.

In one embodiment, the body may be configured such that the size of the aggregate is consistent therethrough. In another embodiment, the body may be configured such that the size of the aggregate adjacent the base is larger than the size of the aggregate adjacent the surface.

Accordingly, in a second aspect of the invention there is provided a method of manufacturing a water permeable paver comprising
mixing an aggregate with cement at a ratio of 5 parts aggregate to 1 part cement;
adding water to said mixture of aggregate and cement so as said mixture of aggregate and concrete forms a plastic concrete state;
pouring said mixture in the plastic concrete state into a mould shaped to define the shape of the paver;
vibrating the mould at a high level for a predetermined period of time until the mixture in the plastic concrete state has achieved a maximum state of compaction;
placing the mould in a curing chamber for a predetermined period of time to cure the paver.

In one embodiment of the second aspect of the invention, the step of mixing the aggregate may comprise making a first mixture of aggregate having a small diameter size and a second mixture of aggregate having a larger diameter size. The first mixture may have an aggregate of the size of between 1-2 mm in diameter. The second mixture may have an aggregate of between 2-7 mm in diameter. Each of the first mixture and the second mixture may be formed into a plastic concrete state through the introduction of water into the mixture.

The step of pouring the mixture of aggregate and concrete in the plastic concrete state into the mould may comprises initially pouring a base layer of mixture in the plastic concrete state into the mould to define a base layer of the paver and secondly pouring a surface layer of mixture in the plastic concrete state into the mould to define a surface layer of the paver. In one embodiment, the base layer may comprises the first mixture of material and the surface layer may comprise. the second mixture of material with a colouring agent added.

The mould may be cured for between 24-48 hours to form said paver.

### BRIEF DESCRIPTION OF THE DRAWINGS

The invention may be better understood from the following non-limiting description of preferred embodiments, in which:

FIG. 1 is a side view of a paver in accordance with an embodiment of the present invention;

FIG. 2 is a top view of the paver of FIG. 1;

FIG. 3 is a side view of a paver in accordance with another embodiment of the present invention;

FIG. 4 is a top view of the paver of FIG. 3;

FIG. 5 depicts two pavers of the type depicted in FIGS. 1 and 2 assembled to form a partially paved path;

FIG. 6 is a side view depicting a paver made by a one-part method in accordance with an embodiment of the present invention;

FIG. 7 is a side view depicting a paver made by a two-part method in accordance with an embodiment of the present invention;

FIG. 8 depicts the paver of FIGS. 1 and 2 absorbing rain water in accordance with the present invention;

FIG. 9 is a cross-sectional view depicting a manner in which the pavers of the present invention may be installed for use; and

FIG. 10 is a flow chart depicting the method for forming the pavers in accordance with a preferred embodiment.

### DETAILED DESCRIPTION OF THE DRAWINGS

Preferred features of the present invention will now be described with particular reference to the accompanying drawings. However, it is to be understood that the features illustrated in and described with reference to the drawings are not to be construed as limiting on the scope of the invention.

The present invention will be described below in relation to its application as a paver for use in paving heavy traffic areas, such as car parks and driveways, as well as industrial areas and roadways. The present invention also has application to walkways, footpaths and the like, in accordance with one embodiment of the present invention. However, it will be appreciated that the paver of the present invention could be used in a variety of different applications still fall within the scope of the present invention.

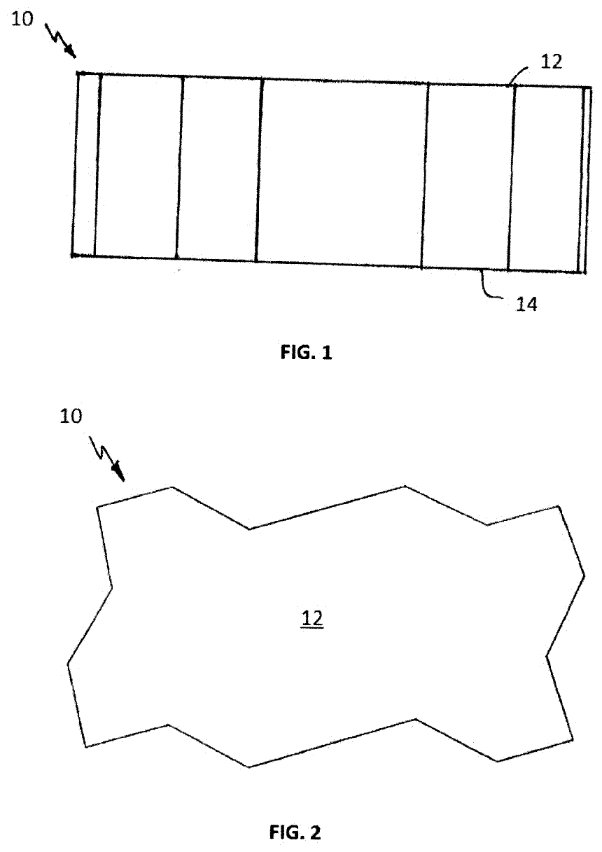

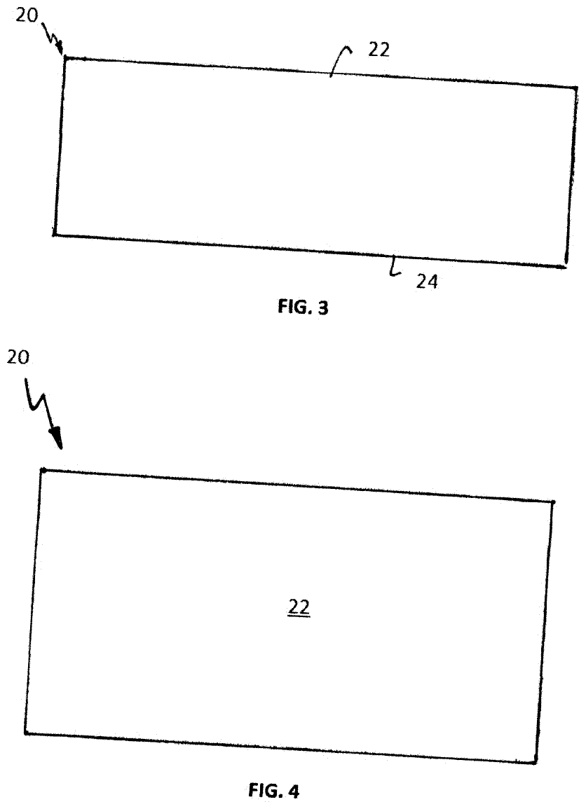

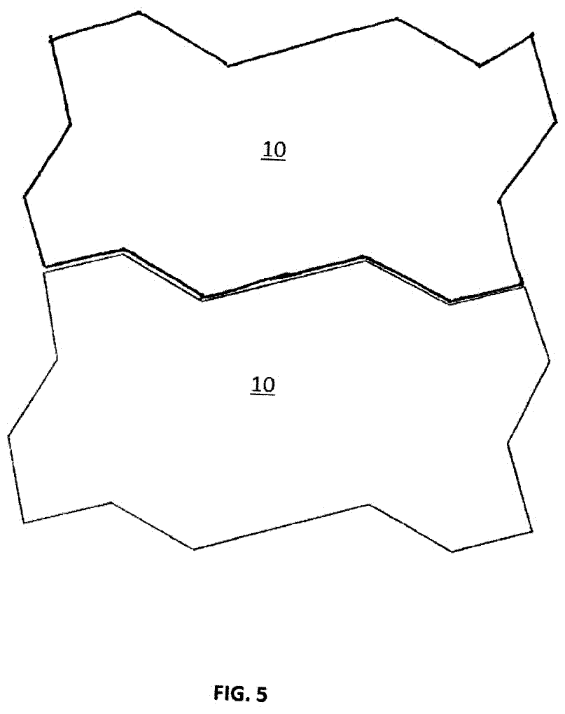

Referring to FIGS. 1 and 2, a paver 10 is depicted in accordance with a first embodiment of the present invention. As is more clearly shown in FIG. 2, the paver 10 has been formed to assume a shape that enables it to interlock with a similarly shaped pavers to form a paved surface in the manner as depicted in FIG. 5. Such a shape enables pavers 10 to be positioned in close proximity such that any torsional force applied to the upper surface 12 of the paver 10 is transmitted and resisted by the adjacent pavers 12 which have multiple contacting surfaces to ensure that the pavers do not move or cause other pavers to move. This is important in such instances where the paved surface created by the pavers 10 supports vehicles such as cars, trucks and forklifts, as the turning wheels of a vehicle when in contact with the upper surface 12 of a paver 10 can cause the pavers to become dislodged if not configured in such an interlocking manner.

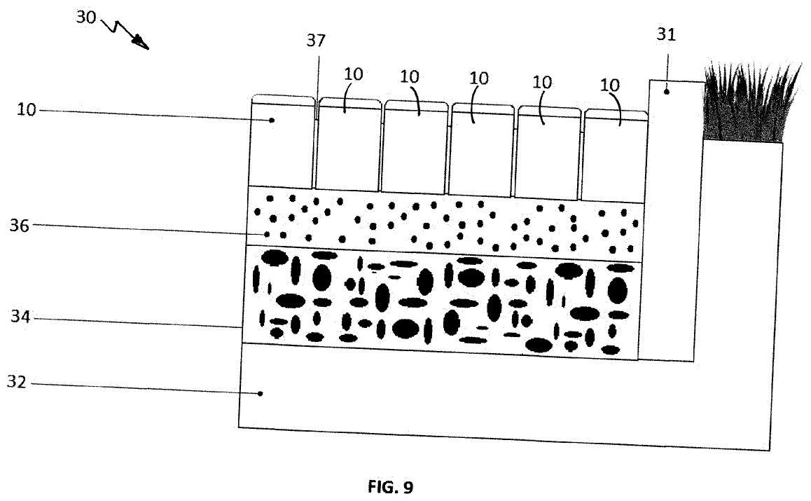

One embodiment depicting a manner in which the pavers 10 may be installed for use is shown in FIG. 9. In this embodiment, the ground surface 32 may be prepared such that it is excavated to an appropriate depth, as shown. An edge restraint 31 positioned in the excavated hole to define an edge to which the pavers 10 abut against. A base layer 34 of aggregate is then deposited on the ground surface 32 having a typical depth of around 80 mm. The base layer 34 typically comprises a course aggregate having a diameter of between 20-25 mm to maximise drainage therethrough. A bedding layer 36 is then formed atop the base layer 34 which may have a depth of around 30 mm. The bedding layer 36 may comprise aggregate having a diameter of between 2-5 mm and may constitute course sand or pea gravel.

The bedding layer 36 may then be levelled to form a base upon which the pavers 10 may be supported. As is shown, the pavers 10 are positioned in close proximity to each other with a small gap 37 formed therebetween. The gap 37 may be at least partially filled with sand to stabilise any movement between pavers 10.

In such a configuration as depicted in FIG. 9, water is able to penetrate through the body of the pavers 10 and through the subsequent layers 36 and 34 to be received in the ground surface 32. Water can then accumulate in the ground surface 32 to provide a rich source of water for local trees and other plant life. It will be appreciated that a water collection or harvesting system may be provided between the ground surface 32 and the base layer 34 or between the base layer 34 and the bedding layer 36. Such a harvesting system may include a storage vessel, or a pipe or conduit that collects the water and delivers it to a remote storage vessel for further use, as will be appreciated by those skilled in the art.

The paver 10 is porous and is formed from a concrete and aggregate mixture. The aggregate may be a natural stone such as basalt, granite, or marble. In one embodiment, the aggregate is crushed marble which is mixed with cement at a ratio of 5:1. The crushed marble typically comprises varying sizes of marble stone varying from pieces having a diameter of between 1 mm-7 mm. In order to provide a variety of aesthetic options, a coloured oxide may also be added to the surface level part of the mixture as desired. Water is used to create the appropriate consistency of mix to form the paver 10.

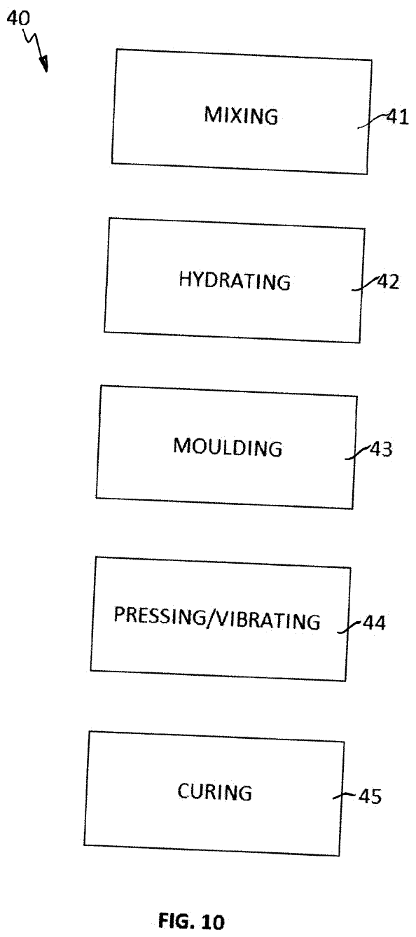

A method 40 for forming the paver 10 is shown in FIG. 10. As a first step 41, the materials are mixed within a large mixing chamber at the above mentioned ratio. In step 42, water is added to the mixture to form the appropriate consistency of the mix, namely a mixture having a plastic concrete state. In step 43, the mixture is then poured into a mould to form the desired shape of the paver. In step 44 the mould is then pressed and vibrated to ensure that the aggregate is freely dispersed throughout the paver, to facilitate the porous and water permeable characteristics of the finished paver. In a preferred form, the vibration applied in step 44 has a frequency of between 50-100 Hz, preferably around 65 Hz and is conducted over a period of between 15-60 seconds duration, preferably in two periods of around 30 seconds duration each. In this regard, when the mould is filled with mixture for forming the base of the paver, the mixture is compressed and is vibrated for the first period of 30 second duration. Any coloured aggregates and materials to form the top portion of the paver are then introduced on top of the base material and the combined material is compressed and the combined material is vibrated for the second period of 30 second duration. The material is then cured to form the final paver product in step 45. The pavers are cured within a curing chamber for between 24-48 hours to accelerate the curing process.

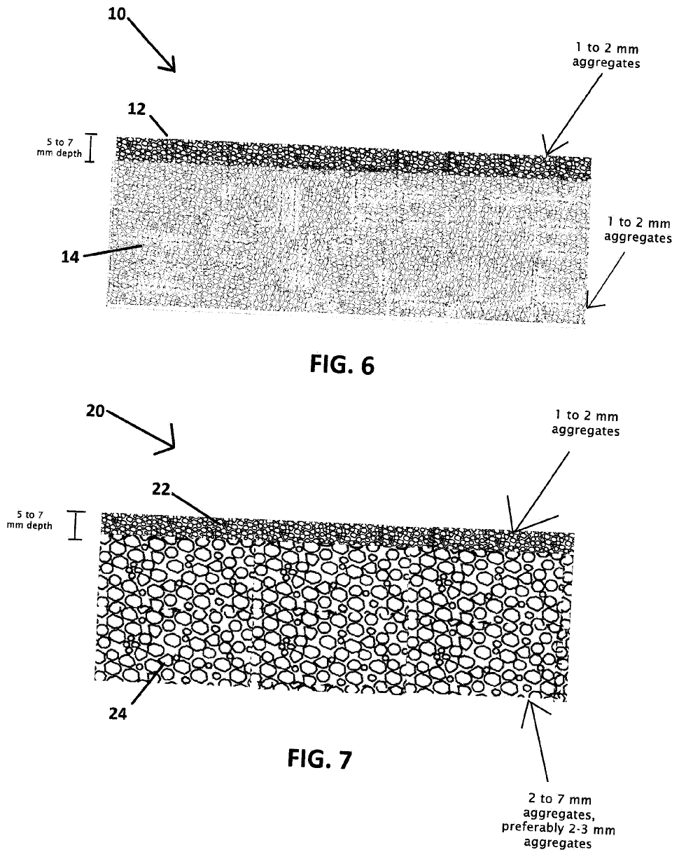

The manufacturing process 40 can be varied to create pavers 10 with different properties. In a first embodiment, the aggregate and the cement may be mixed to provide an even consistency of aggregate throughout the paver 10. To pour the moulds, this is typically done in a two-part process whereby a base layer is initially poured into the mould, followed by the surface layer having a depth of between 5-7 mm and which contains a colouring agent. In this embodiment, whilst the surface layer of the finished paver may have a different colour than the rest of the paver, all of the aggregate size is substantially the same throughout the paver, namely between 1-2 mm in diameter. This process produces a paver 10 having a consistent finish with all aggregate substantially the same size, as is depicted in FIG. 6.

In another form, the paver 10 may be also formed from a two-part process whereby the surface layer 12 and the base layer 14 have different aggregate sizes. In one example of this process, the base layer has a coarser aggregate than the surface layer. In this regard, in one embodiment the base layer 14 may have aggregate of between 2-7 mm in diameter, preferably of between 2-3 mm in diameter, whilst the surface layer comprises aggregate of 1-2 mm in diameter and also contains the colouring agent. As a result, the aggregate is mixed to contain the different proportions and is then added to the mould at different times to create the different layered effect. A paver 10 formed from the two-part process is depicted in FIG. 7.

An alternative embodiment of a paver 20 in accordance with the present invention is depicted in FIGS. 3 and 4. In this embodiment the paver 20 is a conventional rectangular paver and is not configured with the interlocking shape. Such a paver may be used in a variety of applications whereby foot traffic is required, such as paths and borders. The paver 20 has a surface 22 and a base 24 for supporting the paver 20 on a surface to be paved.

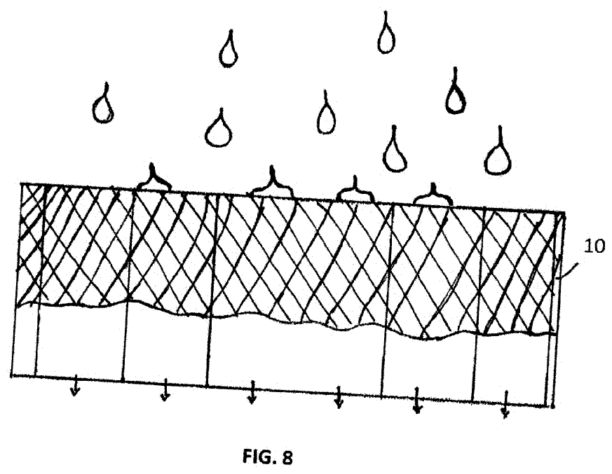

Due to the manner in which the paver 10, 20 is formed, it has sufficient porosity so as to be water permeable such that water that is contact on the surface of the paver 10, 20 will permeate through the body of the paver 10, 20 and into the ground surface below, as is depicted in FIG. 8.

The paver 10, 20 has a minimum permeability rate of 300 mm per hour and as the paver 10, 20 absorbs water it's body does not change shape. Thus, the entire surface area of the paver 10, 20 is able to collect water and retain the water as it passes through the paver 10, 20 to be absorbed into the underlying ground surface. This enables the surface 12, 22 of the paver 10, 20 to be configured to have a high resistance to abrasion to ensure durability, and still be permeable to water. Without the need for any additional treatment, the surface 12, 22 of the paver will also be slip resistant to the required standards, without compromising its' ability to be permeable to water. Similarly, the paver 10, 20 is formed in such a manner that it has a breaking load strength suitable to support industrial and commercial traffic loads.

The pavers 10, 20 may be manufacture to a variety of sizes, as required by the end user. For the interlocking paver 10, the paver may have a length of 225 mm and a width of 112 mm, and a thickness of 60 mm. For the rectangular paver 20, the paver may have a length of around 200 mm and a width of 100 mm with a thickness of around 60 mm. It will be appreciated by those skilled in the art that the dimensions of the paver 10, 20 may vary, together with the thickness to suit a variety of different types of applications.

It will be appreciated that the paver of the present invention offers a variety of benefits that has not been achievable with conventional permeable paving systems that rely upon the spacing between pavers to capture the water. By having the entire surface of the paver acting as a water permeable surface, water will not tend to flow across the pavers of the present invention, but rather be consumed by the pavers, thereby reducing the flow of water collecting in drains and other conventional rainwater collection systems. This then reduces the onset of flash flooding in such regions, as the pavers themselves will hold/retain water that would have otherwise flowed into the drains.

The pavers of the present invention can also be installed about trees/plants in footpaths and roadways so as to collect water and release the water to the underlying ground surface adjacent the tree/plant root system. This ensures that as rainfall or water provided to the tree/plant will not flow away from the plant but will be retained and released to the plant, increasing the health of the tree/plant and reducing the need to install root watering systems and other such devices, which generally require dedicated watering.

Throughout the specification and claims the word “comprise” and its derivatives are intended to have an inclusive rather than exclusive meaning unless the contrary is expressly stated or the context requires otherwise. That is, the word “comprise” and its derivatives will be taken to indicate the inclusion of not only the listed components, steps or features that it directly references, but also other components, steps or features not specifically listed, unless the contrary is expressly stated or the context requires otherwise.

Orientational terms used in the specification and claims such as vertical, horizontal, top, bottom, upper and lower are to be interpreted as relational and are based on the premise that the component, item, article, apparatus, device or instrument will usually be considered in a particular orientation, typically with the paver uppermost.

It will be appreciated by those skilled in the art that many modifications and variations may be made to the methods of the invention described herein without departing from the spirit and scope of the invention.

1. A paving member comprising:
a body having a base configured to be supported on a ground surface and a surface configured to support traffic thereon, the body comprising a combination of aggregate and cement mixed at a ratio of 5:1 such that the body is permeable to water to facilitate collection of water therein and delivery of said water to said ground surface.

2. The paving member of claim 1, wherein the body has a water permeability rate of at least 300 mm per hour.

3. The paving member of claim 1, wherein the body is configured to have a shape that facilitates interlocking with other paving members.

4. A paving member according to claim 1, wherein the aggregate comprises crushed stone.

5. A paving member according to claim 4, wherein the crushed stone may vary in sizes having diameters of between 1 mm-7 mm.

6. A paving member according to claim 1, wherein the body is configured such that the size of the aggregate is consistent therethrough.

7. A paving member according to claim 1, wherein the body is configured such that the size of the aggregate adjacent the base is larger than the size of the aggregate adjacent the surface.

8. A method of manufacturing a water permeable paver comprising:
mixing an aggregate with cement at a ratio of around 5 parts aggregate to 1 part cement;
adding water to said mixture of aggregate and cement so as said mixture of aggregate and concrete forms a concrete plastic state;
pouring said mixture in said concrete plastic state into a mould shaped to define the shape of the paver;
vibrating the mould at a high level for a predetermined period of time until the mixture in the plastic concrete state has achieved a maximum state of compaction; and
placing the mould in a curing chamber for a predetermined period of time to cure the paver.

9. A method according to claim 8, wherein the step of mixing the aggregate comprises making a first mixture of aggregate having a large diameter size and a second mixture of aggregate having a smaller diameter size.

10. A method according to claim 9, wherein the first mixture has aggregate of between 2-7 mm in diameter.

11. A method according to claim 9, wherein the second mixture has aggregate of between 1-2 mm in diameter.

12. A method according to claim 8, wherein the step of pouring the mixture of aggregate and concrete in the plastic concrete state into the mould comprises initially pouring a base layer of mixture in the plastic concrete state into the mould to define a base layer of the paver and secondly pouring a surface layer of mixture in the plastic concrete state into the mould to define a surface layer of the paver.

13. A method according to claim 12, wherein the base layer comprises the first mixture of material and the surface layer contains the second mixture of material with a colouring agent added.

14. A method according to claim 8, wherein the mould is cured for between 24-48 hours to form said paver.

15. A method according to claim 8, wherein the mould is vibrated at a frequency of between 50-100 Hz for a duration of between 15-60 seconds.

16. A method according to claim 15, wherein the mould is vibrated at 65 Hz in two durations of around 30 seconds each.

17. A method according to claim 12, wherein the base layer is vibrated at 65 Hz for a first period of around 30 seconds and upon addition of the surface layer, the base layer and the surface layer are vibrated at 65 Hz for a further 30 seconds duration.
